(19) United States
(12) Patent Application Publication
(10) Pub. No.: US 2026/0016052 A1
(43) Pub. Date: Jan. 15, 2026

(54) COUPLING, AND MEDICAL INSTRUMENT HAVING A COUPLING

(71) Applicant: Aesculap AG, Tuttlingen (DE)

(72) Inventors: Andre Buerk, Villingen-Schwenningen (DE); Aaron Vogler, Leibertingen (DE)

(21) Appl. No.: 18/881,890

(22) PCT Filed: Jul. 6, 2023
(86) PCT No.: PCT/EP2023/068683

§ 371 Date: Jan. 7, 2025

(30) Foreign Application Priority Data
Jul. 8, 2022 (DE) 10 2022 117 074.8

(51) Int. Cl. F16D 1/108

(52) U.S. Cl. CPC F16D 1/108; F16D 2300/12

(57) ABSTRACT

A coupling for a medical instrument includes a rotatable rotor shaft and a shaft. The shaft has a coupling portion that can be inserted axially in the rotor shaft for the purpose of form-fitting, torque-transmitting coupling, as well as an alignment portion which is adjusted to the rotor shaft such that, during coupling, it aligns the shaft in a predetermined rotational position about its longitudinal axis. The alignment portion is axially spaced from the coupling portion of the shaft such that the shaft, during coupling, is aligned in the predetermined rotational position before the coupling portion of the shaft comes into form-fitting, torque-transmitting engagement with the rotor shaft. The coupling can be part of a medical instrument.

### CROSS-REFERENCE TO RELATED APPLICATIONS

This application is the United States national stage entry of International Application No. PCT/EP2023/068683, filed on Jul. 6, 2023, and claims priority to German Application No. 10 2022 117 074.8, filed on Jul. 8, 2022. The contents of International Application No. PCT/EP2023/068683 and German Application No. 10 2022 117 074.8 are incorporated by reference herein in their entireties.

### FIELD

The present disclosure relates to a coupling for a medical instrument, in particular a hand instrument, for the torque-transmitting connection of a shaft to a rotatable rotor shaft. In addition, the present disclosure relates to a medical instrument, in particular a hand instrument, with such a coupling.

### BACKGROUND

For hand instruments, it is often necessary to be able to establish a detachable, torque-transmitting connection to a rotatable rotor shaft in order to again convert the rotation directly into a rotation of a hand instrument tool or indirectly into a coupled motion, such as an angular deflection, of the tool. Couplings are typically used to establish a torque-transmitting connection between two components, with which the torque can be transmitted in a form-fitting manner, for example. Such couplings are known, for example, from DE 10 2012 101 259 A1 or DE 10 2021 118 412 A1.

However, in form-fitting torque transmission, it is crucial that the components to be connected to each other are first aligned to one another in a specific rotational position in order to be able to establish a form-fitting connection in the first place, which, however, depending on the structure of the coupling used, takes place inside the components and thus cannot be visually checked or controlled. It is possible that a user has to try out in a complex manner in which rotational position it is possible to establish a form-fitting connection, and the user may remain unclear as to whether a coupling engagement has occurred, which in turn can lead to misuse of the hand instrument.

### SUMMARY

The present disclosure is based on the task of reducing or avoiding disadvantages of the prior art. In particular, a coupling for a medical instrument, in particular a hand instrument, as well as a medical instrument, in particular a hand instrument, including such a coupling, are to be provided, in which the risk of misuse due to an unsuccessful torque-transmitting connection can be excluded or at least reduced. At the same time, the coupling should be as simple and compact as possible and enable safe torque transmission.

The problem underlying the present disclosure is solved by a coupling for an instrument, in particular a hand instrument, and by an instrument, in particular a hand instrument. Advantageous further features will be described in more detail later.

To put it more precisely, the problem is solved by a coupling for a medical instrument, in particular a hand instrument, which has a rotor shaft that can be driven by rotation, preferably by a drive unit formed as a handpiece, for example, and a shaft. The shaft can be rotationally coupled to a drive shaft, for example, the rotation of which can in turn be coupled to the rotation of a tool or to an angular deflection of the tool.

The shaft has a coupling portion, in particular in the form of a polygonal profile, preferably a hexagon that can be inserted axially into the rotor shaft for the purpose of coupling (/connecting) in a preferably direct, form-fitting, torque-transmitting manner. This means that the rotor shaft has a coupling portion, in particular in the form of a polygonal profile, preferably a hexagon, which is formed so as to be complementary to the coupling portion of the shaft, and with which the coupling portion of the shaft is in form-fitting and torque-transmitting engagement in the coupled state. In other words, for coupling, i.e. for shifting from an uncoupled state in which the rotor shaft and the shaft are disconnected from one another in a torque-transmitting manner/are not connected to one another in a torque-transmitting manner to a coupled state in which the rotor shaft and the shaft are connected to one another in a torque-transmitting manner, the coupling portion of the shaft can be inserted axially into the rotor shaft (/into the coupling portion of the rotor shaft). In particular, the shaft and the rotor shaft are connected via a form-fitting shaft-hub connection, preferably via a direct form-fitting shaft-hub connection, such as a polygon profile/multi-edge profile, a splined shaft profile or a toothed shaft profile. This means that the coupling portion of the shaft preferably interacts directly with the coupling portion of the rotor shaft (i.e. not via radially shiftable locking elements, but via rigid or radially immobile coupling portions) for torque transmission. For example, the coupling portion of the shaft can be formed in the shape of an (external) hexagon and the coupling portion of the rotor shaft can be formed in the shape of an (internal) hexagon. Alternatively, an indirectly form-fitting shaft-hub connection, such as a keyed connection, could be used.

The shaft has an alignment portion that is adjusted to the rotor shaft such that the alignment portion aligns the shaft in a predetermined rotational position about its longitudinal axis during coupling, i.e. when the shaft is inserted axially into the rotor shaft. This also means that the rotor shaft has an alignment contour formed so as to be complementary to the alignment portion of the shaft along which, during coupling, i.e. when the two coupling portions are inserted into each other, the alignment portion is aligned into the predetermined rotational position. In other words, the alignment portion of the shaft and the alignment contour of the rotor shaft are formed to fit in such a way that the alignment portion and the alignment contour can only come into (complete) engagement in one or more specific alignments (relative to the longitudinal axis of the shaft or rotor shaft). For example, the alignment contour is a negative of the alignment portion or has circumferentially spaced contact surfaces for contact with surfaces of the alignment portion. Due to the interaction/guidance of the alignment portion and the alignment contour, the shaft rotates into the correct position relative to the rotor shaft (i.e. is aligned in the correct position), so that in particular the coupling portion of the shaft is aligned to match the coupling portion of the rotor shaft.

According to the present disclosure, the alignment portion is axially spaced from the coupling portion of the shaft such that the shaft is aligned in the predetermined rotational position upon coupling before the coupling portion of the shaft comes into form-fitting torque-transmitting engagement with the rotor shaft. This means that the shaft has a distance portion that is formed axially between the coupling portion and the alignment portion of the shaft and has a large axial length so that alignment via the alignment portion on the alignment contour takes place at a point of time of the axial insertion, at which the distance portion (and not yet the coupling portion) is located in the axial region of the coupling portion of the rotor shaft. Thus, the form-fitting and torque-transmitting connection between the two coupling portions does not yet exist before alignment is concluded since the form-fitting torque-transmitting connection between the two coupling portions would otherwise prevent further relative rotation between the shaft and the rotor shaft or, in case of lacking alignment of the shaft and the rotor shaft, the coupling process, i.e. a further axial insertion, would be blocked. This has the advantage that automatic alignment can be achieved when the shaft is inserted into the rotor shaft.

According to a preferred embodiment, an axial distance between the coupling portion and the alignment portion of the shaft, i.e., the axial length of the distance portion, may be larger than an axial length of the coupling portion of the rotor shaft. This ensures that alignment can be concluded before the coupling portion of the shaft axially immerses into the coupling portion of the rotor shaft or, in the absence of alignment, attempts to do so axially.

According to a preferred embodiment, the alignment contour can directly connect axially to the coupling portion of the rotor shaft in the uncoupled state. This means that in the uncoupled state, there is preferably no distance between the alignment contour and the coupling portion of the rotor shaft. This has the advantage that the axial distance between the coupling portion and the alignment portion of the shaft, i.e. the axial length of the distance portion, only is to be slightly larger than the axial length of the coupling portion of the rotor shaft to ensure proper functioning. Thus, the minimum required length of the shaft can be kept as short as possible.

According to an alternative embodiment, the alignment contour in the uncoupled state can be axially spaced from the coupling portion of the rotor shaft. That is, in the uncoupled state, there is a (predetermined) distance between the alignment contour and the coupling portion of the rotor shaft. According to a further feature of the alternative embodiment, the axial distance between the coupling portion and the alignment portion of the shaft, i.e. the axial length of the distance portion, can be larger than the sum of an axial length of the coupling portion of the rotor shaft and the (predetermined) distance between the alignment contour and the coupling portion of the rotor shaft in the uncoupled state. Thus, even if a (predetermined) distance between the alignment contour and the coupling portion of the rotor shaft is provided, it can be ensured that the alignment is concluded before the coupling portion of the shaft axially immerses into the coupling portion of the rotor shaft.

According to a preferred embodiment, the alignment contour can be formed by an inclined surface that is inclined to the axial direction and radial direction and includes an acute angle with a longitudinal plane of the rotor shaft, i.e., a longitudinal plane containing the longitudinal axis of the rotor shaft. This means that the alignment contour lies in a plane that is inclined to the longitudinal plane. In other words, the alignment contour is formed on an axially and radially inclined contact surface. Due to the axial and radial inclination, the alignment portion with increasing axial insertion rotates around the longitudinal axis of the shaft and makes full-surface contact with the contact surface. Alternatively, the alignment portion of the shaft can also be formed in the shape of an inclined surface or a recess complementary thereto.

According to a preferred embodiment, the alignment portion may be in the form of a pyramidal, i.e., in the form of a pyramid whose central axis corresponds to the longitudinal axis of the shaft. In particular, an edge number of the coupling portion of the shaft can correspond to a side surface number or a multiple of the side surface number of the pyramid. This ensures rotational symmetry between the coupling portion of the shaft and the alignment portion and thus correct alignment with respect to the coupling portion of the shaft. Preferably, the alignment portion can be in the form of a triangular pyramid. Alternatively, the alignment contour of the rotor shaft can also be in the form of the pyramid or a recess complementary thereto.

According to a preferred embodiment, the coupling can have a follower element separate from the rotor shaft, on which the alignment contour is formed. Thus, the follower element can also be exchanged. That is to say that the alignment contour is not integrally formed with the rotor shaft. Preferably, the follower element can be received in the rotor shaft in an axially displaceable manner and can be connected to the rotor shaft in a rotationally fixed manner. The rotationally fixed connection between the rotor shaft and the follower element preferably can be realized by means of a flat portion on the substantially circular outer circumference of the follower element (and a corresponding complementary receiver on the rotor shaft). Axial displaceability is useful to avoid that the follower element does not prevent further axial insertion of the shaft into the rotor shaft after completion of the alignment.

According to a further feature of the preferred embodiment, the follower element can be axially displaceable against a spring preload. Preferably, in the coupled state, the follower element can be in its spring-loaded position. This means on account of the spring preload, the follower element is pushed axially towards the coupling portion of the rotor shaft, so that the axial distance between the coupling portion of the rotor shaft and the follower element, i.e. the alignment contour, is pushed towards zero. This ensures that, in the uncoupled state, the follower element is located at an axial position where the alignment portion can engage with the alignment contour.

According to a preferred embodiment, the coupling can have an insert separate from the rotor shaft, on which the coupling portion of the rotor shaft is formed. This also allows the insert to be replaced. This means that the coupling portion of the rotor shaft is not integrally formed on the rotor shaft. Preferably, the insert can be axially secured in the rotor shaft and connected to the rotor shaft in a rotationally fixed manner. The rotationally fixed connection between the rotor shaft and the insert can preferably be realized by means of a flat on the essentially circular outer circumference of the insert (and a corresponding complementary recess on the rotor shaft). Axial securing is useful to ensure that, in the uncoupled state, the insert is in an axial position where the coupling portion of the shaft can engage the coupling portion of the rotor shaft.

According to a preferred embodiment, the rotor shaft can have a stepped inner diameter so that an axial contact surface for the insert is formed on an axial side facing away from the shaft. This has the advantage that an axial stop is formed for the insert, which limits an axial movement of the insert on its axial side facing away from the shaft.

According to a preferred embodiment, the coupling can have a securing element that is linked to the rotor shaft in an axially fixed manner, preferably via a threaded connection, on an axial side of the insert facing the shaft, so that an axial contact surface for the insert is formed on an axial side facing the shaft. This has the advantage that an axial stop for the insert is formed which limits axial movement of the insert on its axial side facing the shaft.

According to a further development of the preferred embodiment, the securing element may preferably have a screw-in geometry, in particular in the form of an (internal) hexagon, for screwing the securing element into the rotor shaft, which has a larger diameter than the coupling portion of the shaft. The screw-in geometry provides the option of being able to screw the locking element into the rotor shaft. Due to the (inner) diameter of the screw-in geometry being larger than the (outer) diameter of the coupling portion of the shaft, the alignment of the shaft, in particular a rotation around the longitudinal axis of the shaft, when the coupling portion is located in the axial area of the securing element, is not impaired by the locking element.

According to a preferred embodiment the alignment portion and the alignment contour each can be formed by at least one inclined surface, each of the inclined surfaces being inclined towards the axial direction and the radial direction and being formed for flat contact on an inclined surface of the respective other of the alignment portions and the alignment contour, the alignment portion and the alignment contour having a different number of inclined surfaces and/or a different alignment of the inclined surfaces about the longitudinal axis. The different shapes of the alignment portion and the alignment contour can be used to support the flat contact with increasing axial immersion. In contrast to an exact shape match, in which jamming can occur depending on the rotational position, in particular in a “tooth-on-tooth” position, the axial insertion and rotation are gently guided.

The underlying task of the present disclosure is also solved by a medical instrument, in particular a hand instrument. The hand instrument comprises the described coupling, a drive unit, for example in the form of a handpiece, linked to the rotor shaft of the coupling in a torque-transmitting manner, and a drive shaft linked to the shaft in a torque-transmitting manner. The drive shaft can be coupled to a tool in such a way that a rotation of the drive shaft causes the tool to rotate or bend.

According to a preferred embodiment, the instrument can have a shaft sleeve in which the shaft is axially secured and rotatably mounted. Preferably, the coupling has no axial securing means for axially fixed reception of the shaft in the rotor shaft. This has the advantage that the coupling can be designed to be particularly compact. Due to the axial securing of the shaft in the shaft sleeve, axial securing in the rotor shaft is not absolutely necessary.

According to a preferred embodiment, the instrument may comprise a housing in which the drive unit is received (axially fixed). Preferably, the shaft sleeve may comprise a shaft coupling for axial and radial/torque-proof connection to the housing. Thus, the axial securing of the shaft can be realized indirectly via the shaft sleeve and the housing.

In other words, the present disclosure relates to a handpiece with a direct torque transmission from a rotor shaft to a tool shaft, including an alignment so that the torque transmission to a coupled tool or shaft takes place directly via the rotor shaft of the drive unit without any additional intermediate connections. A mechanism built into the rotor shaft and a special tool or shaft geometry ensure that the rotor shaft and the tool/shaft are automatically aligned with each other. Preferably, the torque transmission can be performed in a form-fitting manner via a hexagonal geometry. In particular, a special coupling is used for torque transmission between the handpiece and the shaft, which is particularly compact due to its integration into the rotor shaft. For maximum comfort in coupling the shaft, the coupling is laid out as a plug-and-play coupling. Specifically, the drive shaft is linked to a coupling portion in a torque-proof manner. The drive is provided via a hexagonal shaft. This is directly followed by a cylindrical portion with a pyramid, which is positioned in relation to the hexagon in such a way that it automatically aligns itself before the hexagon engages with the insert of the rotor shaft. It is not necessary to axially secure the drive shaft, so that the corresponding meshing sections on the coupling portion can be omitted and the installation space can be reduced. The drive shaft is axially secured in the shaft and the shaft has its own coupling geometry for axial and radial securing.

The insert in particular may be disposed within, preferably entirely within, the rotor shaft. The insert preferably may be disposed at a distal end portion of the rotor shaft. The follower element may be disposed within, preferably entirely within, the rotor shaft. The follower element preferably is disposed proximally of the insert and further preferably is axially spaced therefrom. The spring preferably can be disposed proximally of the follower element or at least partially in a proximal end portion of the follower element and preferably exerts an axial preload force on the follower element. The spring is preferably received within, further preferably completely within, the rotor shaft. In summary, preferably the insert, the rotor shaft and the spring are arranged, preferably completely, within the rotor shaft, further preferably in that order starting from a distal end portion of the rotor shaft. In other words, the coupling is integrated in the rotor shaft. This results in a particularly compact structure.

The coupling portion of the shaft in particular is configured such that it can be inserted into the rotor shaft, in particular by means of the insert, in order to engage with the follower element within the rotor shaft or to bring the alignment portion within the rotor shaft into engagement with the alignment contour.

### BRIEF DESCRIPTION OF THE DRAWINGS

FIG. 1 is a schematic representation of a coupling for an instrument according to the present disclosure for torque-transmitting connection between a shaft and a rotor shaft in an uncoupled state;

FIG. 2 is a perspective view of an insert forming a coupling portion of the rotor shaft;

FIG. 3 is a perspective view of a follower element forming an alignment contour of the rotor shaft;

FIG. 4 is a perspective view of a securing element for axially securing the insert;

FIG. 5 is a schematic view of the coupling for torque-transmitting connection between the shaft and the rotor shaft in a coupled state;

FIG. 6 is a perspective view of the shaft and a shaft receiving the shaft;

FIG. 7 is a perspective view of the instrument with the coupling according to the present disclosure; and

FIGS. 8 to 11 are different views of the coupling at different times between the uncoupled state and the coupled state.

### DETAILED DESCRIPTION

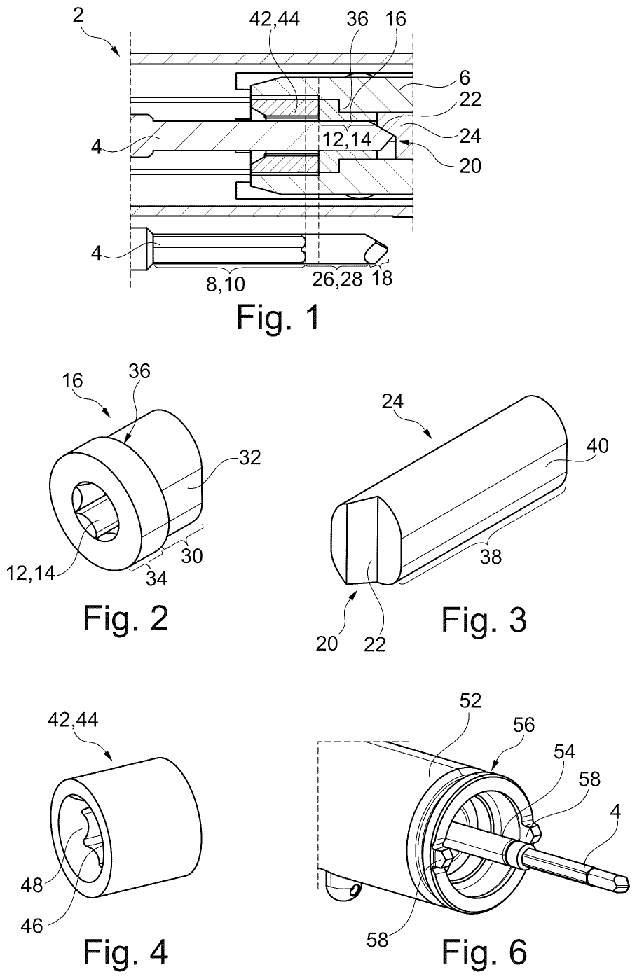

FIG. 1 shows a coupling 2 for a medical instrument, in particular a hand instrument, according to the present disclosure. The coupling 2 has a shaft 4 and a rotor shaft 6, which are connected to one another in a torque-transmitting manner in a coupled state of the coupling 2 and are disconnected from one another in a torque-transmitting manner in an uncoupled state of the coupling 2. For coupling, i.e. for shifting from the uncoupled state into the coupled state, the shaft 4 and the rotor shaft 6 can be axially inserted into each other.

The shaft 4 has a coupling portion 8. In the illustrated embodiment, the coupling portion 8 is in the form of an external hexagon 10. The coupling portion 8 is formed integrally with the shaft 4. Alternatively, the coupling portion 8 could also be formed on a component separate from the shaft 4, which is connected to the shaft 4 in a torque-proof and axially fixed manner.

The rotor shaft 6 has a coupling portion 12, which is formed so as to be complementary to the coupling portion 8 of the shaft 4. In the illustrated embodiment, the coupling portion 12 is formed as a internal hexagon 14. In the coupled state, the coupling portions 8, 12 are connected to one another, preferably directly, in a form-fitting, torque-transmitting manner. The coupling portion 12 is formed on an insert 16 separate from the rotor shaft 6, which is connected in a torque-proof manner to the rotor shaft 6, in particular inserted into the rotor shaft 6 formed as a hollow shaft.

The shaft 4 has an alignment portion 18. The alignment portion 18 is formed at one end of the shaft 4, in particular at a proximal end. In the illustrated embodiment, the alignment portion 18 is in the form of a pyramid extending in the longitudinal direction of the shaft 4. The pyramid is in the form of a triangular pyramid, i.e. the pyramid has three side surfaces. The alignment portion 18 is formed integrally with the shaft 4. Alternatively, the alignment portion 18 could also be formed on a component separate from the shaft 4, which is connected to the shaft 4 in a torque-proof and axially fixed manner.

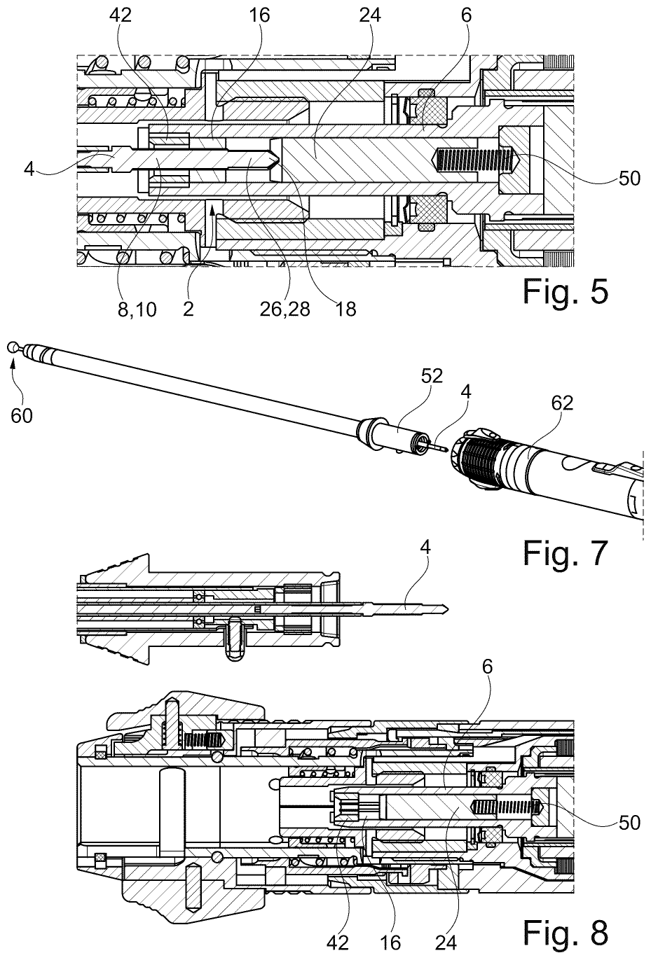

The rotor shaft 6 has an alignment contour 20. The alignment contour 20 serves to receive and align the alignment portion 18 in a predetermined rotational position about a longitudinal axis of the shaft 4 and the rotor shaft 6, respectively. In particular, the alignment contour 20 is designed such that, when the alignment portion 18 is inserted axially into the alignment contour 20, the coupling portion 8 of the shaft 4 is aligned with the coupling portion 12 of the rotor shaft 6. In the illustrated embodiment, the alignment contour 20 is formed in the shape of an inclined surface 22, which is inclined to the axial direction and radial direction. The inclined surface 22 forms an acute angle with a longitudinal plane of the rotor shaft 6, i.e. a plane containing the longitudinal axis of the rotor shaft 6. The alignment contour 20 is formed on a follower element 24 that is separate from the rotor shaft 6 and is connected to the rotor shaft 6 in a torque-proof manner, in particular is inserted in the rotor shaft 6, which is formed as a hollow shaft. The follower element 24 is received in the rotor shaft 6 in an axially displaceable manner (see FIG. 5).

In other words, the alignment contour 20 is designed to match the alignment portion 18 in such a way that the alignment portion 18 and the alignment contour 20 can only engage (completely) in one or more specific alignments. The alignment contour 20, for example, is a negative of the alignment portion 18, or has distributed contact surfaces for contact with surfaces of the alignment portion 18 in a circumferential direction. Due to an interaction/guidance of the alignment portion 18 and the alignment contour 20 the shaft 4 rotates into the correct position relative to the rotor shaft 6 (i.e. is aligned into a correct position), so that in particular the coupling portion 8 (i.e. the external hexagon 10) is aligned to match the coupling portion 12 (i.e. to the internal hexagon 14).

The shaft 4 has a distance portion 26. The distance portion 26 is arranged axially between the coupling portion 8 and the alignment portion 18. In particular, the coupling portion 8 on one side directly joints the distance portion 26, and, on the other side, the alignment portion 18 directly joins the distance portion 26. An outer contour of the distance portion 26 is adjusted to the coupling portion 12 of the rotor shaft 6 such that the shaft 4 can rotate freely relative to the rotor shaft 6 when the distance portion 26 axially is in the region of the coupling portion 12. Preferably, the distance portion 26 can have an external diameter that is smaller than an internal diameter of the coupling portion 12. In the illustrated embodiment, the distance portion 26 is in the form of a circular cylinder 28. The distance portion 26 is formed integrally with the shaft 4. Alternatively, the distance portion 26 could also be formed on a component separate from the shaft 4, which is connected to the shaft 4 in a torque-proof and axially fixed manner.

According to one aspect of the disclosure, the alignment portion 18 is axially spaced from the coupling portion 8 of the shaft 4 such that, when the shaft 4 is inserted axially in the rotor shaft 6, the shaft 4 is aligned into the predetermined rotational position before the coupling portion 8 of the shaft 4 comes into form-fitting, torque-transmitting engagement with the coupling portion 12 of the rotor shaft 6. This is achieved in particular in that an axial distance between the coupling portion 8 and the alignment portion 18 of the shaft 4, i.e. an axial length of the distance portion 26, is larger than an axial length of the coupling portion 12 of the rotor shaft 6.

In the uncoupled state, the alignment contour 20 is directly axially adjacent to the coupling portion 12 of the rotor shaft 6. This means that in the uncoupled state, the follower element 24 rests against the insert 16 (see FIG. 1). Alternatively, the alignment contour 20 could also be arranged axially spaced from the coupling portion 12 in the uncoupled state. In this case, the axial distance between the coupling portion 8 and the alignment portion 18 of the shaft 4, i.e. the axial length of the distance portion 26, can be larger than a sum of the axial length of the coupling portion 12 of the rotor shaft 6 and an axial distance between the alignment contour 20 and the coupling portion 12 of the rotor shaft 6.

FIG. 2 shows a perspective view of the insert 16. The insert 16 has a first, essentially circular, outer circumferential portion 30, on which a flat portion 32 is formed. The rotor shaft 6 has a first inner circumferential portion that is complementary to the first outer circumferential portion 30 of the insert 16, so that the insert 16 is received in the rotor shaft 6 in a torque-proof manner due to the flat portion 32. The insert 16 has a second, essentially circular outer circumferential portion 34, which has a larger diameter than the first outer circumferential portion 30, so that a radial step with an axial contact surface 36 is formed axially between the two outer circumferential portions 30, 34. The rotor shaft 6 has a second inner circumferential portion complementary to the second outer circumferential portion 32 of the insert 16, so that the insert 16 rests against the rotor shaft 6 with its axial contact surface 36. This forms a proximal axial stop for the insert 16 in the rotor shaft 6.

FIG. 3 shows a perspective view of the follower element 24. The follower element 24 has a substantially circular outer circumferential portion 38, on which a flat portion 40 is formed. The rotor shaft 6 has an inner circumferential portion that is complementary to the outer circumferential portion 38 of the follower element 24, so that the follower element 24 is received in the rotor shaft 6 in a torque-proof manner by means of the flat portion 40.

FIG. 4 shows a perspective view of a securing element 42. The securing element 42 is used to axially secure the insert 16 in the rotor shaft 6. The securing element 42 is connected to the rotor shaft 6 in an axially fixed manner and is arranged on a distal side of the insert 16. An inner diameter of the securing element 42 is smaller than an outer diameter of the insert 16, so that the securing element 42 rests axially against the insert 16 (or the insert 16 cannot be led axially through the securing element 42). This forms a distal axial stop for the insert 16 in the rotor shaft 6.

In the illustrated embodiment, the securing element 42 is formed as a threaded sleeve 44 having an external thread on its outer circumference. The rotor shaft 6 has an inner circumferential portion that is complementary to the external thread, i.e. a corresponding internal thread, so that the threaded sleeve 44 can be screwed in the rotor shaft 6. In order to screw the threaded sleeve 44 into the rotor shaft 6, the threaded sleeve 44 has a screw-in geometry 46 on its inner side, which in the illustrated embodiment is formed as an internal hexagon. Preferably, an inner diameter of the screw-in geometry 46 is larger than an outer diameter of the coupling portion 8 of the shaft 4, so that the shaft 4 can be freely rotated relative to the rotor shaft 6 when the coupling portion 8 is located axially in the area of the screw-in geometry 46. The screw-in geometry 46 enlarges via a funnel portion 48 towards its distal end.

FIG. 5 shows a longitudinal section of the coupling 2 in the coupled state. As the shaft 4 is inserted axially further into the rotor shaft 6, the shaft 4 displaces the follower element 24. The follower element 24 is received in the rotor shaft 6 so as to be axially displaceable, against the force of a spring 50. The shaft 4 is inserted in the rotor shaft 6 until the two coupling portions 8, 12 are preferably fully in form-fitting torque engagement with each other. Thus, in the coupled state, the alignment portion 18 and the distance portion 16 extend axially (on a proximal side of the insert 16) beyond the insert 16.

FIG. 6 shows a perspective view of a shaft sleeve 52 of the instrument, in which a drive shaft 54 (centered) is received. The drive shaft 54 is firmly connected to the shaft 4, i.e. in a torque-transmitting/torque-proof and axially fixed manner. The drive shaft 54 is axially secured in the shaft sleeve 52 and is mounted rotatably relative to the shaft sleeve 52. The shaft sleeve 52 has an axial coupling geometry 56, here in the form of a circumferential groove, as well as a radial coupling geometry 58, here in the form of two axial projections distributed over the circumference, by means of which the shaft sleeve 52 can be secured axially and radially.

FIG. 7 shows a perspective view of the instrument. It is to be seen that on a distal side a tool 60 is accommodated in the shaft sleeve 52. The tool 60 can be coupled to the drive shaft 54 or to the shaft 4, preferably in a torque-transmitting manner. The shaft sleeve 52 can be coupled to a housing 62, which in turn accommodates a drive unit. The rotor shaft 6 can be driven in rotation by the drive unit.

FIGS. 8 to 11 show a coupling process of coupling 2. This means that FIGS. 8 to 11 show different representations of coupling 2 at different points of time between the uncoupled state and the coupled state.

In FIG. 8, the shaft 4 is not yet inserted axially in the rotor shaft 6. The shaft 4 and the rotor shaft 6 can rotate freely in relation to each other. The coupling 2 is in the uncoupled state.

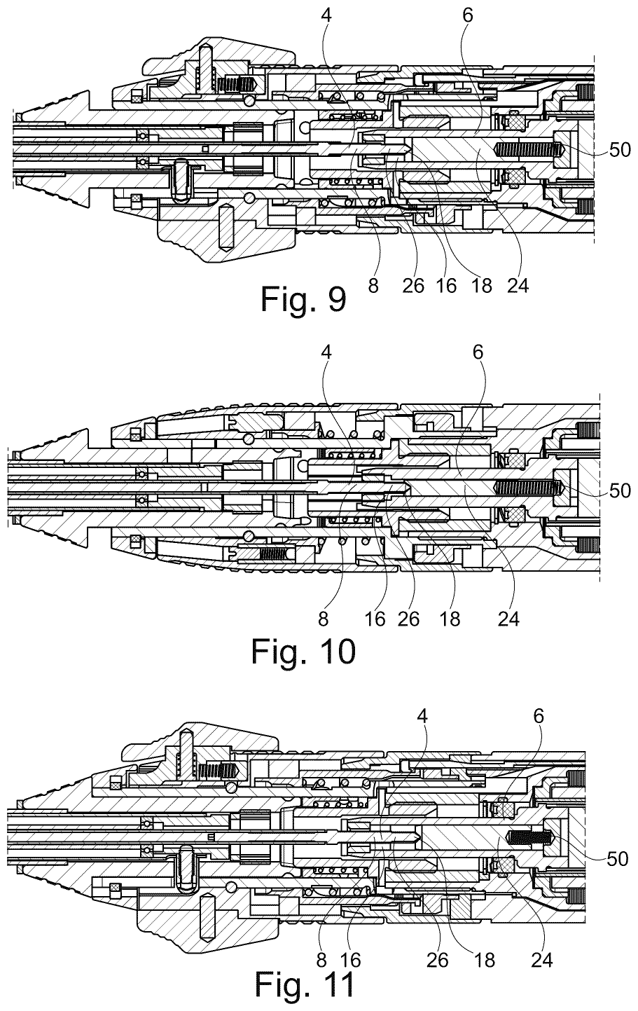

In FIG. 9 and FIG. 10, the shaft 4 is inserted in the rotor shaft 6 to such an extent that the alignment portion 18 of the shaft 4 comes into contact with the alignment contour 20 of the rotor shaft 6. The coupling portion 8 of the shaft 4 is not yet in the axial area of the coupling portion 12 of the rotor shaft 6. The shaft 4 and the rotor shaft 6 can rotate freely in relation to each other. The coupling 2 is still in the uncoupled state. The axial insertion causes the alignment portion 18 to be guided along the alignment contour 20, so that the side surfaces rest against one another (see in particular the top view in FIG. 10). This causes the shaft 4 to be rotated about its longitudinal axis into the predetermined rotational position.

In FIG. 11, the shaft 4 is inserted axially in the rotor shaft 6 to such an extent that the alignment contour 20 (in the form of the follower element 24) is pushed back axially against the spring preload. The coupling portion 8 of the shaft 4 is located in the axial area of the coupling portion 12 of the rotor shaft 6. The shaft 4 and the rotor shaft 6 are in form-fitting engagement with one another. The coupling 2 is in the coupled state.

1.-13. (canceled)

14. A coupling for a medical instrument, the coupling comprising:
a rotor shaft that is rotatable, the rotor shaft comprising a first coupling portion; and
a shaft comprising a second coupling portion and an alignment portion,
the first coupling portion being formed so as to be complementary to the second coupling portion, wherein the second coupling portion is axially insertable in the rotor shaft for form-fitting and torque-transmitting coupling,
the alignment portion being adjusted to the rotor shaft such that, when coupled, the alignment portion aligns the shaft into a predetermined rotational position about a longitudinal axis of the shaft,
the alignment portion being axially spaced from the second coupling portion such that during coupling, the shaft is aligned in the predetermined rotational position before the second coupling portion comes into form-fitting, torque-transmitting engagement with the rotor shaft, and
an axial distance between the second coupling portion and the alignment portion of the shaft is larger than an axial length of the second coupling portion of the rotor shaft.

15. The coupling according to claim 14, wherein:
the rotor shaft comprises an alignment contour formed so as to be complementary to the alignment portion of the shaft and along which the alignment portion is aligned into the predetermined rotational position during coupling, and
the alignment contour, in an uncoupled state, is directly adjacent to the first coupling portion.

16. The coupling according to claim 15, wherein the second coupling portion is insertable in the rotor shaft in order to bring the alignment portion inside the rotor shaft into engagement with the alignment contour.

17. The coupling according to claim 15, wherein:
the alignment portion is formed by at least one first inclined surface,
the alignment contour is formed by at least one second inclined surface,
each of the at least one first inclined surface and each of the at least one second inclined surface is inclined in an axial direction and a radial direction,
each of the at least one first inclined surface is configured for flat contact on one of the at least one second inclined surface,
the at least one first inclined surface comprising a first number of inclined surfaces, and
the at least one second inclined surface comprising a second number of inclined surfaces, the second number being different than the first number.

18. The coupling according to claim 15, wherein:
the alignment portion is formed by at least one first inclined surface,
the alignment contour is formed by at least one second inclined surface,
each of the at least one first inclined surface and each of the at least one second inclined surface is inclined in an axial direction and a radial direction,
each of the at least one first inclined surface is configured for flat contact on one of the at least one second inclined surface,
the at least one first inclined surface having a first alignment about the longitudinal axis, and
the at least one second inclined surface having a second alignment about the longitudinal axis different from the first alignment.

19. The coupling according to claim 15, wherein the alignment contour is formed by an inclined surface which is inclined with respect to an axial direction and a radial direction and forms an acute angle with a longitudinal plane of the rotor shaft.

20. The coupling according to claim 15, further comprising a follower element, the follower element being separate from the rotor shaft, forming the alignment contour, being received in an axially displaceable manner in the rotor shaft, and being connected to the rotor shaft in a torque-proof manner.

21. The coupling according to claim 20, wherein the follower element comprises a outer circumference that is circular and has a flat portion on the outer circumference, wherein the flat portion connects the follower element to the rotor shaft in a torque-proof manner.

22. The coupling according to claim 20, wherein the follower element is axially displaceable against a spring preload and, in a coupled state, the follower element is located in a spring-preloaded position.

23. The coupling according to claim 22, further comprising a spring for applying the spring preload, the spring being arranged proximally to the follower element, or is at least partially received in a proximal end portion of the follower element.

24. The coupling according to claim 23, wherein the spring is arranged within the rotor shaft.

25. The coupling according to claim 15, further comprising:
a follower element, the follower element being separate from the rotor shaft, forming the alignment contour, being received in an axially displaceable manner in the rotor shaft, and being connected to the rotor shaft in a torque-proof manner; and
an insert that is separate from the rotor shaft and arranged within the rotor shaft, the insert forming the first coupling portion and secured axially fixed in the rotor shaft, the insert being connected to the rotor shaft in a torque-proof manner,
wherein the insert is arranged distally from the follower element.

26. The coupling according to claim 15, further comprising:
a follower element, the follower element being separate from the rotor shaft, forming the alignment contour, being received in an axially displaceable manner in the rotor shaft, and being connected to the rotor shaft in a torque-proof manner; and
an insert that is separate from the rotor shaft and arranged within the rotor shaft, the insert forming the first coupling portion and secured axially fixed in the rotor shaft, the insert being connected to the rotor shaft in a torque-proof manner,
wherein the insert and the follower element are arranged within the rotor shaft, the insert being arranged distally from the follower element.

27. The coupling according to claim 14, wherein the alignment portion has a pyramid shape.

28. The coupling according to claim 14, further comprising an insert that is separate from the rotor shaft and arranged within the rotor shaft, the insert forming the first coupling portion and secured axially fixed in the rotor shaft, the insert being connected to the rotor shaft in a torque-proof manner.

29. The coupling according to claim 28, wherein:
the insert comprises an outer circumference that is circular and a flat portion on the outer circumference, and
wherein the flat portion connects the insert to the rotor shaft in a torque-proof manner.

30. The coupling according to claim 28, further comprising a securing element connected axially fixedly to the rotor shaft on an axial side of the insert facing the shaft so that an axial contact surface for the insert is formed on the axial side of the insert facing the shaft.

31. The coupling according to claim 30, wherein the securing element comprises a screw-in geometry for screwing the securing element in the rotor shaft, the screw-in geometry having a larger diameter than the second coupling portion.

32. A medical instrument, comprising:
the coupling according to claim 14;
a drive unit connected to the rotor shaft in a torque-transmitting manner; and
a drive shaft connected to the shaft in a torque-transmitting manner.
